(19) United States
(12) Patent Application Publication
(10) Pub. No.: US 2011/0292449 A1
(43) Pub. Date: Dec. 1, 2011

(54) FLATBED SCANNER WITH CROPPING MARKER

(76) Inventor: Hin Leong Tan, Sunnyvale, CA (US)

(21) Appl. No.: 12/788,111

(22) Filed: May 26, 2010

(51) Int. Cl. H04N 1/04; G06K 15/00

(52) U.S. Cl. 358/1.18; 358/497

(57) ABSTRACT

A scanning system includes a transparent plate and a first crop marker. A document to be scanned is placed upon the transparent plate. The first crop marker is mounted on first housing for the scanning system located adjacent to a first edge of the transparent plate. The first crop marker allows a user to specify a value for a first dimension of a final image to be produced by the scanning system. The scanning system detects a location of the first crop marker and crops the final image of the document in accordance with the value of the first dimension.

### BACKGROUND

Flatbed scanners typically perform a preview scan of an image that generates preview image data. The preview image data is then displayed in a viewing region of a user interface. The user interface allows the user to select an image region of the scanned preview image. A final scan is performed on the image region selected by the user.

The preview scan provides a user with great flexibility in selecting the image region; however, the use of a preview scan does require steps to be performed by the user before the final scan is performed. These steps performed before the final scan can be cumbersome and time consuming depending upon the speed of the scanner and the processing software.

### SUMMARY

In accordance with an embodiment of the invention, a scanning system includes a transparent plate and a first crop marker. A document to be scanned is placed upon the transparent plate. The first crop marker is mounted on first housing for the scanning system located adjacent to a first edge of the transparent plate. The first crop marker allows a user to specify a value for a first dimension of a final image to be produced by the scanning system. The scanning system detects a location of the first crop marker and crops the final image of the document in accordance with the value of the first dimension.

### BRIEF DESCRIPTION OF THE DRAWINGS

FIG. 1 is a simplified top view of a flatbed scanner.

FIG. 2 is a simplified cross-sectional view of a flatbed scanner that includes crop markers in accordance with an embodiment of the invention.

FIG. 3 is a simplified top view of a flatbed scanner that includes crop markers in accordance with an embodiment of the invention.

FIG. 4 is a simplified cross-sectional view of a crop marker shown in FIG. 2 in accordance with an embodiment of the invention.

FIG. 5 outlines a scanned image in accordance with an embodiment of the invention.

FIG. 6 is a simplified flowchart illustrating use of crop markers to crop imaged scanned with a flatbed scanner in accordance with an embodiment of the invention.

FIG. 7 is a simplified flowchart illustrating use of crop markers to crop imaged scanned with a flatbed scanner in accordance with another embodiment of the invention.

FIG. 8 is a simplified top view of a flatbed scanner that includes crop markers in accordance with an embodiment of the invention.

FIG. 9 is a simplified flowchart illustrating use of crop markers to crop imaged scanned with a flatbed scanner in accordance with another embodiment of the invention.

FIG. 10 is a simplified flowchart illustrating use of variable resistors in the implementation of crop markers to crop imaged scanned with a flatbed scanner in accordance with another embodiment of the invention.

FIG. 11 is a simplified top view of a flatbed scanner that includes crop markers in accordance with an embodiment of the invention.

FIG. 12 is a simplified cross-sectional view of the flatbed scanner shown in FIG. 11.

FIG. 13 a simplified cross-sectional view of one side of the flatbed scanner shown in FIG. 11.

FIG. 14 is a simplified cross-sectional view of a crop marker shown in FIG. 2 in accordance with an alternative embodiment of the invention.

FIG. 15 outlines a scanned image in accordance with an alternative embodiment of the invention.

### DESCRIPTION OF THE EMBODIMENT

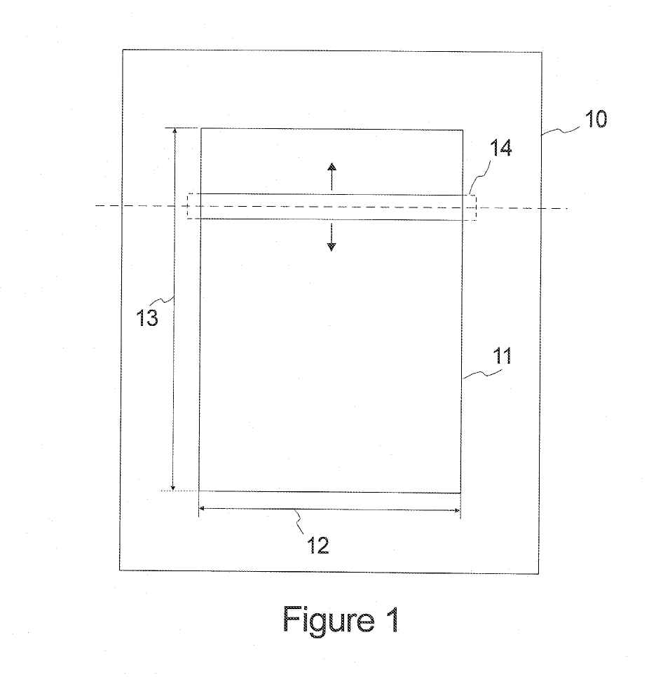

FIG. 1 is a simplified top view of a flatbed scanner 10. A contact image sensor (CIS) head 14 travels under a transparent plate 11 in order to scan an image of a document placed on top of transparent plate 11. For example, transparent plate 11 is composed of glass or other transparent material. The maximum scanning dimension are illustrated in FIG. 1 by a maximum scanning width 12 and a maximum scanning height 13.

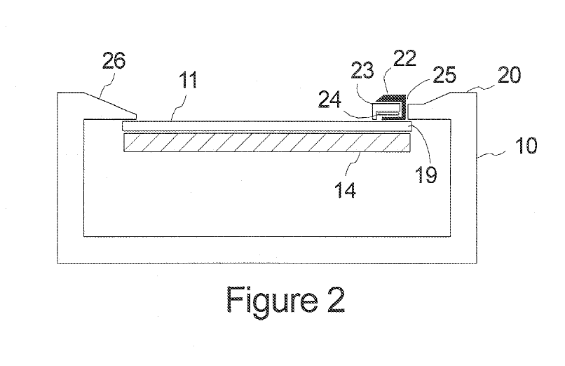

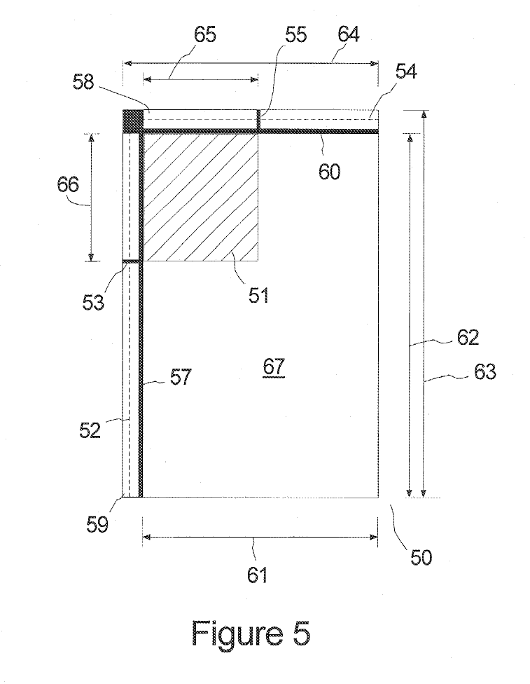

FIG. 2 is a simplified cross-sectional view of flatbed scanner 10 as modified to allow for use of a crop marker. Housing section 23 is located along the entire height of transparent plate 11. A white strip 24 placed under housing section 23 is visible through transparent plate 11 to CIS head 14 during a scan. As illustrated by FIG. 5, a black pixel line optionally appears on the bottom of white strip 24 where it is visible to CIS head 14 during a scan. A crop marker 22, located in a slot 25 between housing section 23 and a housing section 20, is a slider which slides along housing section 23 to indicate a user selection of a scanning height for the document. A housing section 26 is located on the other side of transparent plate 11. An extended region 19 of glass plate 11 extends under housing section 23 to housing section 20 and is thus not seen from the top view of flatbed scanner 10 shown in FIG. 1.

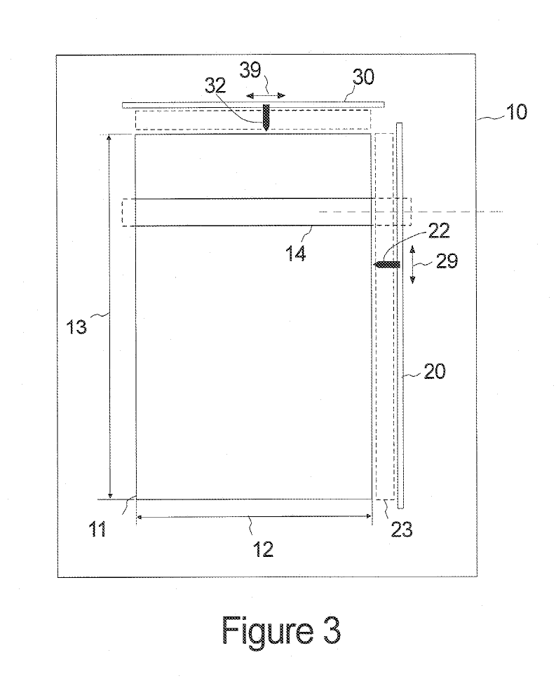

FIG. 3 is a simplified top view of flatbed scanner 10 that shows crop marker 22 and a crop marker 32. Crop marker 32 slides in a horizontal direction 39. Crop marker 22 slides in a vertical direction 29.

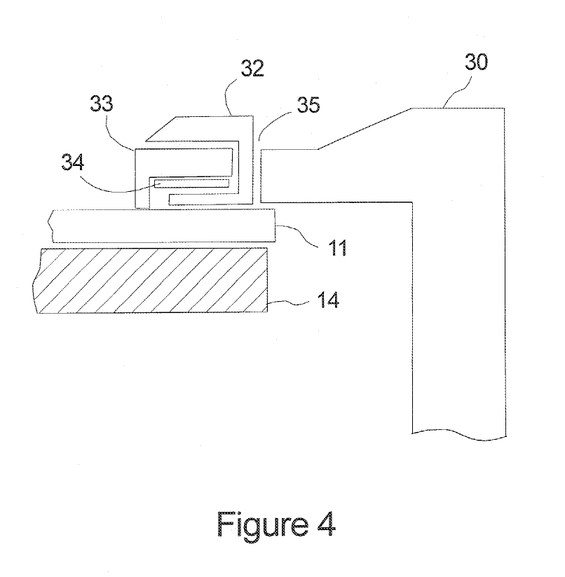

As shown in FIG. 4, crop marker 32, located in a slot 35 between a housing section 33 and a housing section 30, is a slider which slides along housing section 33 to indicate a user selection of a scanning width for the document. A white strip 34 placed under a housing section 33 is visible through transparent plate 11 to CIS head 14 during a scan. As illustrated by FIG. 5, a black pixel line optionally appears on the bottom of white strip 34 where it is visible to CIS head 14 during a scan.

FIG. 4 is a simplified cross-sectional view providing a close-up view of crop marker 32, housing 33 and white strip 34.

FIG. 5 shows a scanned image 50 obtained from flatbed scanner 10. Scanned image 50 appears horizontally flipped because it is an image scanned from underneath by CIS head 14.

Scanned image 50 is an image resulting from an initial scan of a document that a user placed on transparent plate 11 of flatbed scanner 10, as shown in FIG. 3. The user then placed crop marker 32 to mark the width of the document and placed crop marker 22 to mark the height of the document. An image of crop marker 32 appears in FIG. 5 as black mark 55. An image of crop marker 22 appears in FIG. 5 as black mark 53.

In order to produce image 50, CIS 14 scans a full extended scan width 64 along a full extended scan height 63. Scanner software searches along a middle of an extended region 58 for a location of dark region 55 indicating a location of crop marker 32. In FIG. 5, the middle of extended region 58 is represented by a dashed line 54. Dashed line 54 is to illustrate a location within extended region 58 and in embodiments of the invention need not be visible on image 50. The scanner software also searches along a middle of an extended region 59 for a location of dark region 53 indicating a location of crop marker 22. In FIG. 5, the middle of extended region 59 is represented by a dashed line 52.

Upon finding dark region 53 and dark region 55, scanner software crops scanned image 50 to produce a cropped scanned image 51 with a width 65 and a height 66, rather than a full size scanned image 67 which has a maximum width 61 and a maximum height 62.

A dark region 57 in image 50 results from scanning along slot 25 between housing section 23 and a housing section 20. A dark region 60 in image 50 results from scanning along slot 35 between housing section 33 and a housing section 30.

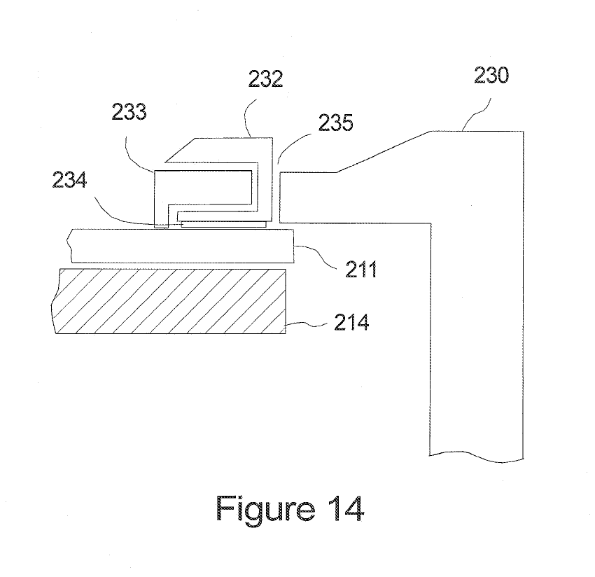

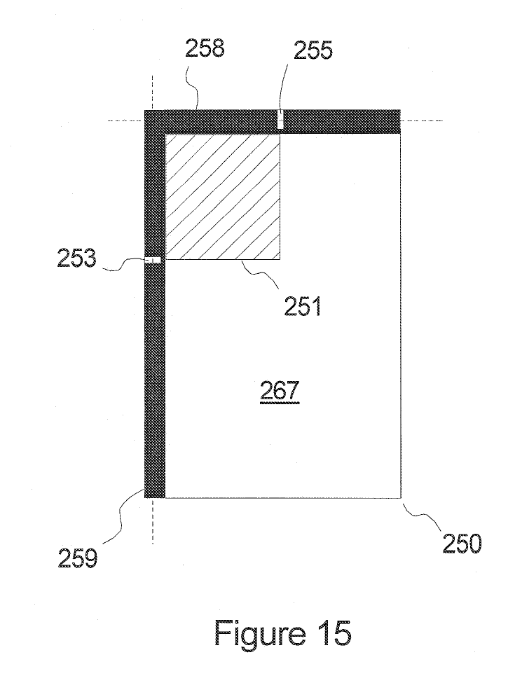

FIG. 14 and FIG. 15 shown an alternate embodiment to the scanner shown in FIG. 4 and FIG. 5. FIG. 14 is a simplified cross-sectional view providing a close-up view of a crop marker 232 and housing 233. Crop marker 232 is located in a slot 235 between crop marker 232 and a housing section 230. Also shown in FIG. 14 are a portion of a glass plate 211, a CIS head 214. A white strip 234 is attached to the bottom of crop marker 232 and allows the scanner to detect the location of crop marker from the scanned image.

FIG. 15 shows a scanned image 250 obtained from a flatbed scanner. Scanned image 250 appears horizontally flipped because it is an image scanned from underneath by CIS head 214.

Scanned image 250 is an image resulting from an initial scan of a document that a user placed on transparent plate 211. The user placed crop marker 232 to mark the width of the document and another crop marker to mark the height of the document. An image of crop marker 232 appears in FIG. 15 as a white mark 255, as a result of the presence of white strip 234 on the bottom of crop marker 232. White mark 253 indicates the location of another crop marker.

In order to produce image 250, CIS 214 scans a full extended scan width along a full extended scan height. Scanner software searches along a middle of an extended region 258 for a location of white region 255 indicating a location of crop marker 232. The scanner software also searches along a middle of an extended region 259 for a location of dark region 253 indicating a location of another crop marker.

Upon finding light region 253 and light region 255, scanner software crops scanned image 250 to produce a cropped scanned image 251, rather than a full size scanned image 267.

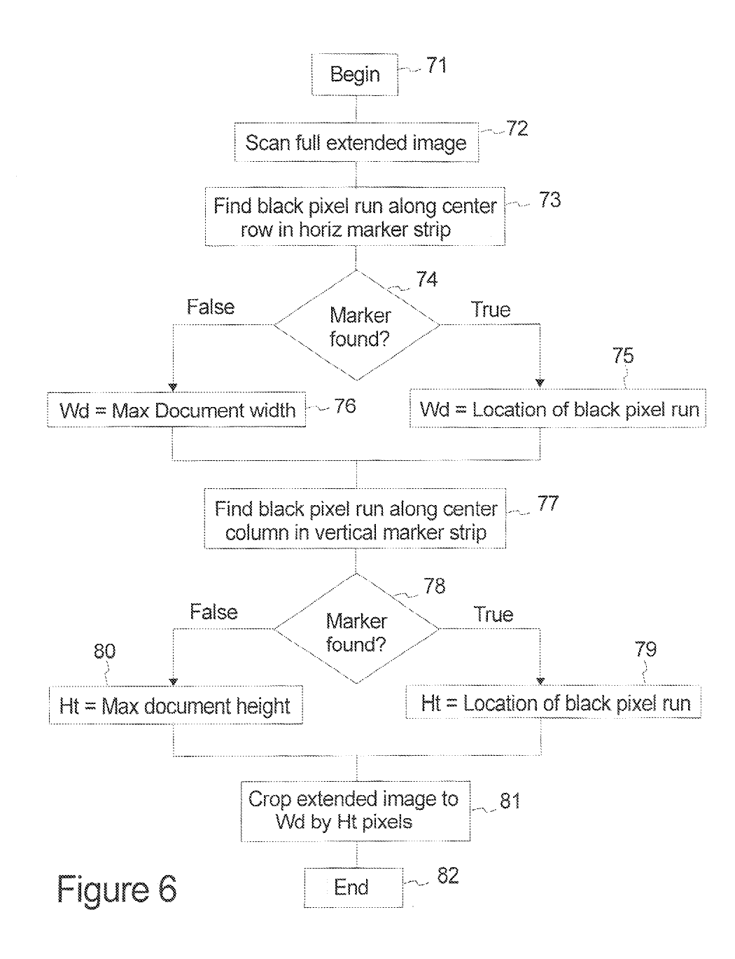

FIG. 6 is a simplified flowchart illustrating how a scanner, including the scanner software that drives the scanner hardware, uses crop markers to crop a scanned image obviating the use of a preview scan.

In a step 71, the scanning process begins. In a step 72, a scan is made of the full extended image, for example as defined in FIG. 5 by full extended scan width 64 and full extended scan height 63. The full extended scan includes extended region 58 and extended region 59. In a step 73, the scanner searches extended region 58 for dark region 55 indicating a location of crop marker 32. From a step 74, if the scanner finds dark region 55, in a step 75 the scanner recognizes that width 65 to the dark region 55 is the width (Wd) for the final image. For the alternative embodiment shown in FIGS. 14 and 15, the location of the crop marker is indicated by a white region.

If from step 74 the scanner does not find dark region 55 within extended region 58, in a step 75 the scanner recognizes that maximum width 61 is the width (Wd) for the final image.

In a step 77, the scanner searches extended region 59 for dark region 53 indicating a location of crop marker 22. From a step 78, if the scanner finds dark region 53, in a step 79 the scanner recognizes that height 66 to the dark region 53 is the height (Ht) for the final image. For the alternative embodiment shown in FIGS. 14 and 15, the location of the crop marker is indicated by a white region. If from step 78 the scanner does not find dark region 53 within extended region 59, in a step 80 the scanner recognizes that maximum height 62 is the height (Ht) for the final image.

In a step 81, the scanner crops the extended image to a final image with width (Wd) and height (Ht) being dimensions of the final image. In a step 82, the generation of the final image is complete.

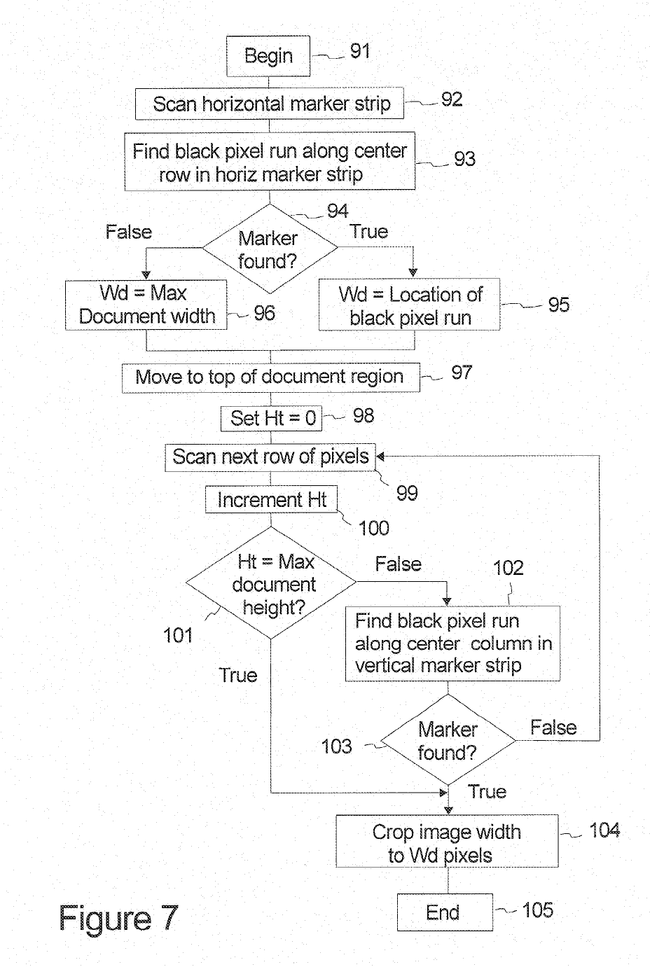

FIG. 7 is a simplified flowchart illustrating another method by which a scanner, including the scanner software that drives the scanner hardware, can use crop markers to crop a scanned image obviating the use of a preview scan.

In a step 91, the scanning process begins. In a step 92, a scan is made of extended region 58. In a step 93, the scanner searches extended region 58 for dark region 55 indicating a location of crop marker 32. For the alternative embodiment shown in FIGS. 14 and 15, the location of the crop marker is indicated by a white region. From a step 94, if the scanner finds dark region 55, in a step 95 the scanner recognizes that width 65 to the dark region 55 is the width (Wd) for the final image. If from step 94 the scanner does not find dark region 55 within extended region 58, in a step 95 the scanner recognizes that maximum width 61 is the width (Wd) for the final image.

In a step 97, the scanner moves to the top of image 67. In a step 98, scanner sets the height (Ht) for the final image as being equal to 0. In a step 99, a next row of pixels is scanned. In a step 100, the value of height (Ht) is incremented to reflect the height of the row of pixels.

In a step 101, a check is made to see whether the height (Ht) for the final image is now equal to maximum height 62 for the final image. If not, in a step 102 the scanner searches most recently scanned pixels within extended region 59 for dark region 53 indicating a location of crop marker 22. From a step 103, if the scanner does not find dark region 53 within extended region 59, the scanner returns to step 99 and scans a next row of pixels.

If from step 103, the scanner finds dark region 53, the scanner goes to step 104 with the scanner recognizing that height 66 to the dark region 53 is the height (Ht) for the final image. If from step 101, the height (Ht) for the final image is now equal to maximum height 62 for the final image, the scanner also reaches step 104 with the scanner recognizing that maximum height 62 is the height (Ht) for the final image.

In step 104, the scanner crops the extended image to a final image with determined width (Wd) and height (Ht) for the final image. In a step 105, the generation of the final image is complete.

In another embodiment of the present invention, immediately after finding the horizontal crop marker at the top of the page, the vertical marker strip can be immediately scanned looking for the vertical crop marker. After the vertical marker is found, then the document is scanned.

Using two crop markers for width and two crop markers for height provides additional flexibility to a user in defining the region to be used as a final scan.

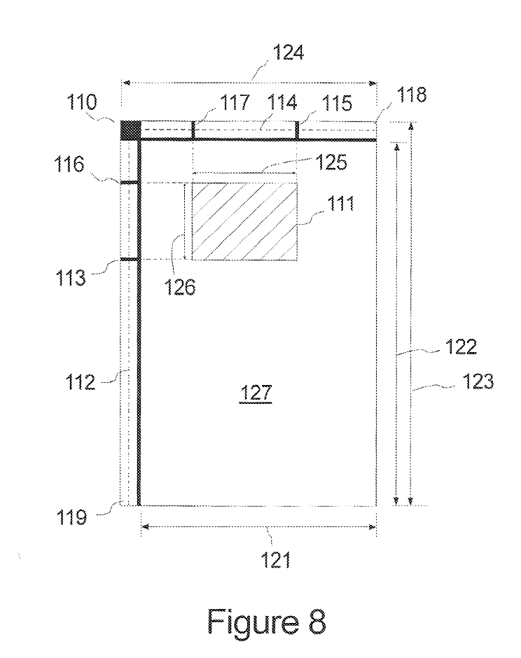

For example, FIG. 8 shows a scanned image 110 obtained from flatbed scanner 10. Scanned image 110 appear horizontally flipped because it is an image scanned from underneath by a CIS head.

Scanned image 110 is an image resulting from an initial scan of a document a user placed on transparent plate 11 of a flatbed scanner 10. The user then placed two crop markers to mark the width of the document and placed two crop markers to mark the height of the document. Images of the two crop markers to mark the width appear as a black mark 115 and a black mark 117 in FIG. 8. Images of the two crop markers to mark the height appear as a black mark 113 and a black mark 116.

In order to produce image 110, a full extended scan of width 124 along a full extended scan height 123. Scanner software searches along a middle of an extended region 118 for locations of dark region 115 and dark region 117 indicating a location of crop markers. In FIG. 8, the middle of extended region 118 is represented by a dashed line 114. The scanner software also searches along a middle of an extended region 119 for a locations of dark region 113 and dark region 116 indicating a location of crop markers. In FIG. 8, the middle of extended region 119 is represented by a dashed line 112.

Upon finding the four dark regions representing crop markers, scanner software crops scanned image 110 to produce a cropped scanned image 111 with a width 125 and a height 126, rather than a full size scanned image 127 that has a maximum width 121 and a maximum height 122.

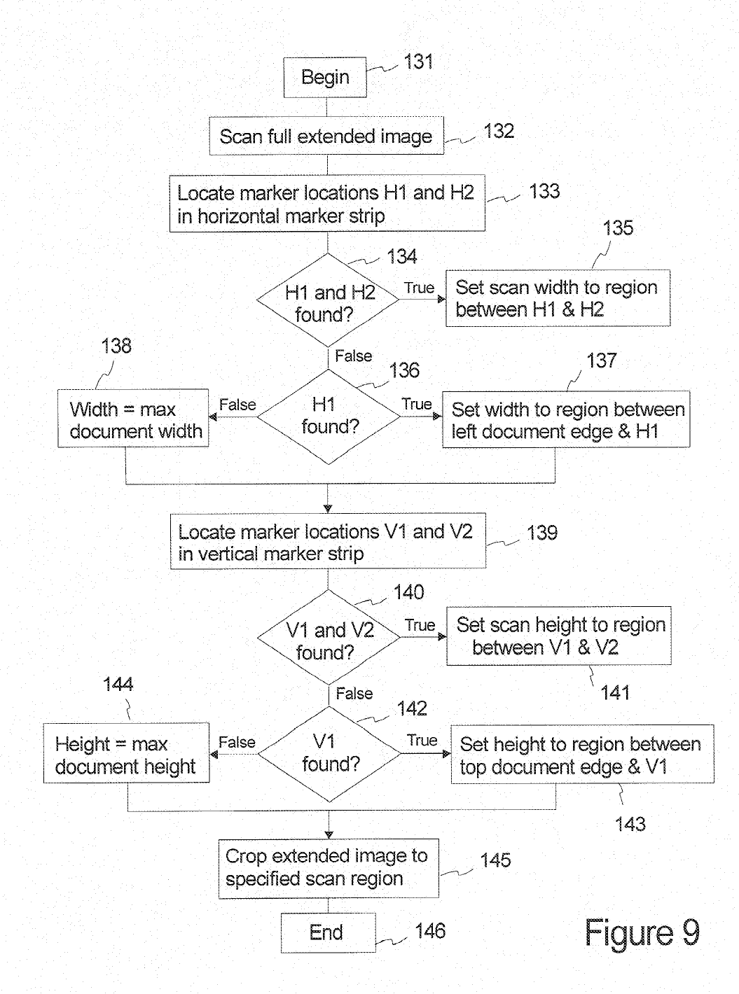

FIG. 9 is a simplified flowchart illustrating how a scanner, including the scanner software that drives the scanner hardware, uses crop markers to crop a scanned image obviating the use of a preview scan.

In a step 131 the scanning process begins. In a step 132, a scan is made of the full extended image, for example as defined in FIG. 8 by full extended scan width 124 and full extended scan height 123. The full extended scan includes extended region 118 and extended region 119. In a step 133, the scanner searches extended region 118 for dark regions 115 and 117 indicating locations of crop markers for image width. From a step 134, if the scanner finds both dark region 115 and dark region 117, in a step 135 the scanner recognizes that the width between the two dark regions is the width (Wd) for the final image. In alternative embodiments of the present invention, the crop markers can be indicated by a white color or some other color.

If from step 134 the scanner does not find both dark region 115 and dark region 117 within extended region 118, in a step 136 a check is made to see if one of dark region 115 and dark region 117 is found. If one of dark region 115 and dark region 117 is found, in step 137 the scanner recognizes that the width between the left edge of full sized scanned image 127 and the found dark region is the width (Wd) for the final image.

If in step 136 no dark regions are found within extended region 118, in a step 138 the scanner recognizes that maximum width 121 is the width (Wd) for the final image.

In a step 139, the scanner searches extended region 119 for dark regions 113 and 116 indicating locations of crop markers for image height. From a step 140, if the scanner finds both dark region 113 and dark region 116, in a step 141 the scanner recognizes that the height between the two dark regions is the height (Ht) for the final image. In alternative embodiments of the present invention, the crop markers can be indicated by a white color or some other color.

If from step 140 the scanner does not find both dark region 113 and dark region 116 within extended region 119, in a step 142 a check is made to see if one of dark region 113 and dark region 116 is found. If one of dark region 113 and dark region 116 is found, in step 143 the scanner recognizes that the height between the top edge of full sized scanned image 127 and the found dark region is the height (Ht) for the final image.

If in step 142 no dark regions are found within extended region 119, in a step 144 the scanner recognizes that maximum height 122 is the height (Ht) for the final image.

In a step 145, the scanner crops the extended image to a final image with determined width (Wd) and height (Ht) for the final image. In a step 146, the generation of the final image is complete.

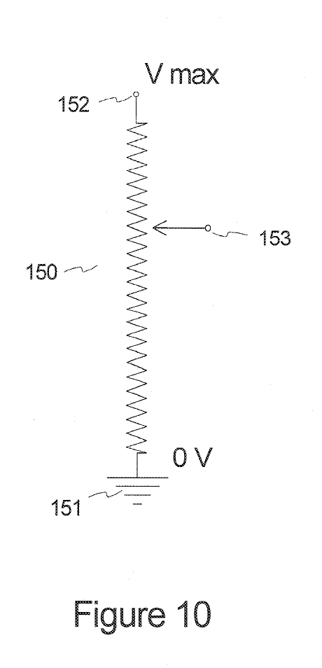

Crop markers can be implemented in document scanner in other ways than using extended regions. For example, variable resistors can be used to implement crop markers. This illustrated, for example, by FIG. 10.

In FIG. 10, a resistor 150 is electrically connected between a maximum voltage (V max) power source 152 and a ground 151 at 0 volts. Resistor 150 is embedded along an edge of an image area in a flatbed scanner. A node 153 is mechanically connected to a crop marker. As the crop marker is positioned along the edge of the image area, node 153 connects to different points of resistor 150. The voltage on node 153 thus varies based on the location of the crop marker and allows the voltage on node 153 to be used to determine the location of the crop markers on the edge.

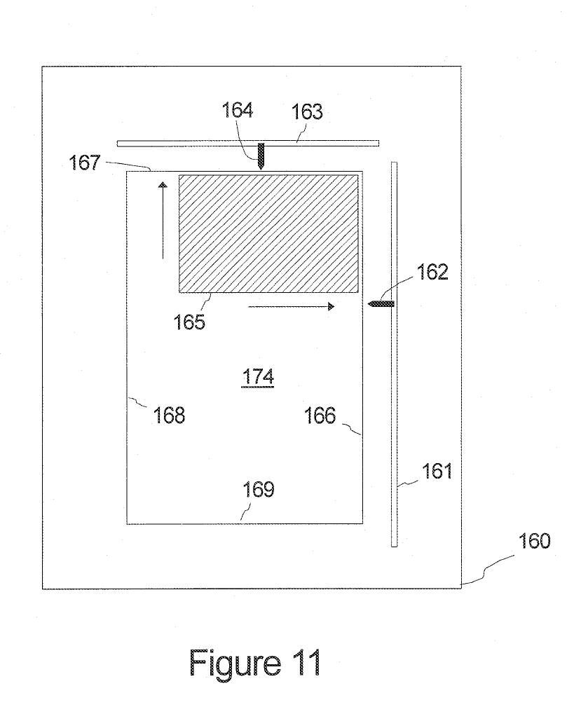

FIG. 11 is a simplified top view of a flatbed scanner 160. A crop marker 162 slides along a housing section 161. A crop marker 164 slides along a housing section 163. A housing edge 167 and a housing edge 166 are raised above a transparent plate 174. A housing edge 168 and a housing edge 169 are flush with or slightly below transparent plate 174, allowing for easy removal of a document 165 from transparent plate 174.

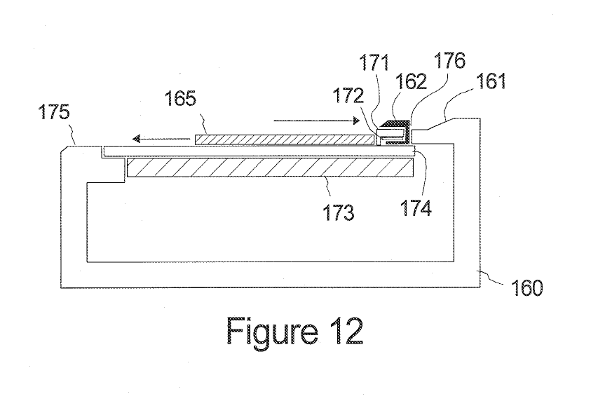

FIG. 12 is a simplified cross-sectional view of flatbed scanner 160. Housing section 161 is located along the entire height of transparent plate 174. A white strip 172 is placed under housing section 162 where it is visible to a CIS head 173 during a scan. Crop marker 162, located in a slot 176 between housing section 161 and a housing section 171, is a slider that slides along housing section 161 to indicate a user selection of a scanning height for the document. A housing section 175 is located on the other side of transparent plate 174. Housing section 175 if flush to transparent plate allowing easy removal of document 165 after document 165 is scanned.

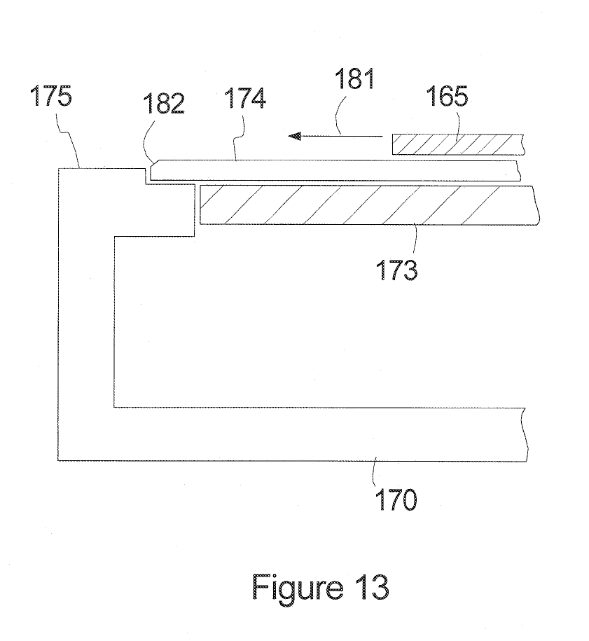

FIG. 13 a simplified cross-sectional view showing housing section 175 being slightly below transparent plate 174 allowing document to be easily removed from transparent plate 174 by sliding document 165 in a direction 181. When housing section 175 is slightly below transparent plate 174, transparent plate 174 can include a beveled edge 182 adjacent to housing section 175.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

I claim:

1. A scanning system comprising:
a transparent plate upon which is placed a document to be scanned; and
crop markers which allow a user to specify a width and a height of a final image to be produced from a scan of the document, the crop markers being located over extended regions of the transparent plate so that the crop markers can be detected by the scanner, the scanned image of the crop markers indicating to the scanner the width and height of the final image indicated by the user.

2. A scanning system as in claim 1 wherein there is a single crop marker which allows the user to specify the width of the final image and there is a single crop marker which allows the user to specify the height of the final image.

3. A scanning system as in claim 1 wherein there are two crop markers which allow the user to specify the width of the final image and there are two crop markers which allow the user to specify the height of the final image.

4. A scanning system as in claim 1 wherein the crop markers slide along housing sections of the scanning system that are located above the extended regions of the transparent plate.

5. A scanning system as in claim 1 where there are two extended region, one along a vertical edge of the transparent plate and one along a horizontal edge of the transparent plate.

6. A scanning system as in claim 1 wherein housing on at least one edge of the transparent plate is flush or below the transparent plate allowing the document to slid off the transparent plate.

7. A scanning system as in claim 1 wherein:
a first crop marker is located on a first edge of the transparent plate;
a second crop marker is located on a second edge of the transparent plate,;
housing along a third edge of the transparent plate is flush or below the transparent plate;
housing along a fourth edge of the transparent plate is flush or below the transparent plate; and,
the first edge is perpendicular to the second edge.

8. A method for producing a cropped image of a document placed on a flatbed scanner, the method, comprising;
performing an extended scan of the document, the extended scan including scanning a first extended region where a first crop marker is located, the first crop marker indicating a first dimensional length of the cropped image selected by a user; and,
cropping the results of the extended scan of the image in accordance with the location of the crop marker in order to produce the cropped image.

9. A method as in claim 8 wherein performing the extended scan of the document includes the following:
scanning the document in the document's entirety to produce a full extended image; and,
searching for an image of the first crop marker in the full extended image.

10. A method as in claim 8 wherein performing the extended scan of the document includes the following:
scanning the document in the document's entirety to produce a full extended image that includes the first extended region; and,
searching for an image of the first crop marker in the first extended region.

11. A method as in claim 8 wherein performing the extended scan of the document includes the following:
scanning the document in the document's entirety to produce a full extended image that includes the first extended region and a second extended region;
searching for an image of the first crop marker in the first extended region; and,
searching for an image of a second crop marker in the second extended region, the second crop marker indicating a second dimensional length of the cropped image selected by the user.

12. A method as in claim 8 wherein performing the extended scan of the document includes the following:
scanning the document in the document's entirety to produce a full extended image that includes the first extended region; and,
searching for an image of the first crop marker and a second crop marker in the first extended region, the first crop marker and the second crop marker together indicating the first dimensional length of the cropped image selected by the user.

13. A method as in claim 8 wherein performing the extended scan of the document includes the following:
scanning the document in the document's entirety to produce a full extended image that includes the first extended region and a second extended region;
searching for an image of the first crop marker and a second crop marker in the first extended region, the first crop marker and the second crop marker together indicating the first dimensional length of the cropped image selected by the user; and,
searching for an image of a third crop marker and a fourth crop marker in the second extended region, the third crop marker and the fourth crop marker together indicating a second dimensional length of the cropped image selected by the user.

14. A method as in claim 8 wherein performing the extended scan of the document includes the following:
scanning the document and concurrently scanning a second extended region while searching for an image of a second crop marker in the second extended region, the second crop marker indicating a second dimensional length of the cropped image selected by the user, the scanning of the document being regarded as complete upon the image of the second crop marker being found.

15. A method as in claim 8 wherein performing the extended scan of the document includes the following:
searching for an image of the first crop marker and a second crop marker in the first extended region, the first crop marker and the second crop marker together indicating the first dimensional length of the cropped image selected by the user; and,
scanning the document and concurrently scanning a second extended region while searching for an image of a third crop marker and an image of a fourth crop marker in the second extended region, the third crop marker and the fourth crop marker indicating a second dimensional length of the cropped image selected by the user, the scanning of the document being regarded as complete upon both the image of the third crop marker and the image of the fourth crop marker being found.

16. A method for producing a cropped image of a document placed on a flatbed scanner, the method, comprising;
performing an extended scan of the document, the extended scan including scanning a first extended region where a first crop marker is located, the first crop marker indicating a height of the cropped image selected by a user; and,
cropping the results of the extended scan of the image in accordance with the location of the crop marker in order to produce the cropped image.

17. A method as in claim 16 wherein performing the extended scan of the document includes the following:
scanning the document in the document's entirety to produce a full extended image that includes the first extended region; and,
searching for an image of the first crop marker in the first extended region.

18. A method as in claim 16 wherein performing the extended scan of the document includes the following:
scanning the document in the document's entirety to produce a full extended image that includes the first extended region; and,
searching for an image of the first crop marker and a second crop marker in the first extended region, the first crop marker and the second crop marker together indicating the height of the cropped image selected by the user.

19. A method as in claim 16 wherein performing the extended scan of the document includes the following:
scanning the document and concurrently scanning the first extended region while searching for an image of the first crop marker in the first extended region, the scanning of the document being regarded as complete upon the image of the first crop marker being found.

20. A method as in claim 16 wherein performing the extended scan of the document includes the following:
scanning the document and concurrently scanning the first extended region while searching for an image of the first crop marker and an image of a second crop marker in the first extended region, the scanning of the document being regarded as complete upon both the image of the first crop marker and the image of the second crop marker being found, wherein the first crop marker and the second crop marker together indicate the height of the cropped image selected by the user.

21. A scanning system comprising:
a transparent plate upon which is placed a document to be scanned;
first housing located adjacent to a first edge of the transparent plate, wherein the first housing is flush or below the transparent plate allowing the document to slid off the transparent plate over the first housing; and
second housing located adjacent to a second edge of the transparent plate, wherein the second housing is above the transparent plate allowing the document to be aligned by the second housing.

22. A scanning system as in claim 21, additionally comprising:
third housing located adjacent to a third edge of the transparent plate, wherein the third housing is flush or below the transparent plate allowing the document to slid off the transparent plate over the third housing; and,
fourth housing located adjacent to a fourth edge of the transparent plate, wherein the fourth housing is above the transparent plate allowing the document to be aligned by the fourth housing.

23. A scanning system as in claim 21, additionally comprising:
third housing located adjacent to a third edge of the transparent plate, wherein the third housing is flush or below the transparent plate allowing the document to slid off the transparent plate over the third housing.

24. A scanning system as in claim 21, additionally comprising:
third housing located adjacent to a third edge of the transparent plate, wherein the third housing is flush or below the transparent plate allowing the document to slid off the transparent plate over the third housing; and,
fourth housing located adjacent to a fourth edge of the transparent plate, wherein the fourth housing is above the transparent plate allowing the document to be aligned by the fourth housing;
wherein the second edge is perpendicular to the fourth edge.

25. A scanning system as in claim 21, additionally comprising:
a first crop marker located over the second edge of the transparent plate, the first edge of the transparent plate being parallel to the second edge of the transparent plate;

26. A scanning system as in claim 25 additionally comprising:
a second crop marker located over a third edge of the transparent plate.

27. A scanning system comprising:
a transparent plate upon which is placed a document to be scanned; and,
a first crop marker mounted on first housing for the scanning system located adjacent to a first edge of the transparent plate, the first crop marker allowing a user to specify a value for a first dimension of a final image to be produced by the scanning system;
wherein the scanning system detects a location of the first crop marker and crops the final image of the document in accordance with the value of the first dimension.

28. A scanning system as in claim 27 additionally comprising:
a second crop marker mounted on second housing for the scanning system located adjacent to a second edge of the transparent plate, the first crop marker allowing a user to specify a value for a second dimension of the final image to be produced by the scanning system;
wherein the scanning system detects a location of the second crop marker and crops the final image of the document in accordance with the value of the first dimension.

29. A scanning system as in claim 27 additionally comprising:
a first resistor embedded within the first housing, the first crop marker including a first node that is in contact with the first resistor, a voltage on the first node indicating the value for the first dimension of the final image to be produced by the scanning system.

30. A scanning system as in claim 27 additionally comprising:
a first resistor embedded within the first housing, the first crop marker including a first node that is in contact with the first resistor, a voltage on the first node indicating the value for the first dimension of the final image to be produced by the scanning system;
a second crop marker mounted on second housing for the scanning system located adjacent to a second edge of the transparent plate, the first crop marker allowing a user to specify a value for a second dimension of the final image to be produced by the scanning system, wherein the scanning system detects a location of the second crop marker and crops the final image of the document in accordance with the value of the first dimension; and,
a second resistor embedded within the second housing, the second crop marker including a second node that is in contact with the second resistor, a voltage on the second node indicating the value for the second dimension of the final image to be produced by the scanning system.

31. A scanning system as in claim 27 wherein the first crop marker is located over an extended region of the transparent plate so that the first crop marker can be detected by the scanning system when the scanning system scans the document, the scanned image of the first crop marker indicating to the scanning system either the width or height of the final image indicated by the user.
